(19) United States
(12) Patent Application Publication
(10) Pub. No.: US 2013/0211983 A1
(43) Pub. Date: Aug. 15, 2013

(54) ON-GOING CUSTOMER RISK ASSESSMENT OF A FINANCIAL INSTITUTION CUSTOMER POPULATION

(71) Applicant: Alvin Lee, Charlotte, NC (US)

(72) Inventor: Alvin Lee, Charlotte, NC (US)

(73) Assignee: Bank of America Corporation, Charlotte, NC (US)

(21) Appl. No.: 13/397,425

(22) Filed: Feb. 15, 2012

(51) Int. Cl. G06Q 40/00

(52) U.S. Cl. 705/35

(57) ABSTRACT

Systems, apparatus, methods and computer program products are described for providing standardized risk assessments to a global financial institution customer population. Specifically, risk assessment provides for risk ranking the customer population throughout the lifecycle of the customer's relationship with the financial institution. In specific embodiments, the risk ranking efficiently includes three concise risk rank tiers; standard risk, medium risk and high risk. Such tier or level-based risk ranking does not rely on risk scoring each of the customers and, therefore, provides an accurate, efficient and simplified means of risk assessment that can be implemented across an entire customer population. In addition, since the risk ranking does not directly rely on customer transaction data, the risk ranking herein described is more accurate and efficient in identifying those customers that truly present a money laundering risk.

### FIELD

In general, embodiments of the invention relate to and risk assessment, more particularly, risk ranking financial institution customers throughout the lifecycle of the customer's relationship with the financial institution.

### BACKGROUND

Financial institutions implement various means to monitor the occurrence of customer events, such as transactions or the like, deemed to be suspicious in nature. Identification of such suspicious activity may provide insight into illegal customer activities, such as money laundering, fraud or the like.

In addition to monitoring for the occurrence of such suspicious activity, it is highly beneficial for financial institutions to be able to gauge which of their customers provide the highest risk for engaging in such activity. By knowing which of their customers are most at risk for participating in suspicious or illegal activities, the financial institution can heighten the level of monitoring imposed on such high-risk customers.

Currently, customer risk assessment by financial institutions is limited to assessing the risk posed by a customer at the time customer initiates the relationship with the financial institution (commonly referred to as the “onboarding” of the customer) or when the customer procures more services from the financial institution (e.g., opens additional accounts, secures a loan in the future or the like). Such a risk assessment is generally limited to customer profile information provided by the customer and verified by the financial institution (e.g., customer type (e.g., consumer vs. business), citizenship, employment type, business location, business type, and the like). In addition to generally being limited to customer profile information, such risk assessments do not reflect the fact a customer's risk to the financial institution may change over time during the lifecycle of the customer's relationship with the financial institution. Such fluctuations in risk may be based on customer experience/activities both internal to the financial institution and external to the financial institution.

Therefore a need exists to develop a customer risk assessment process that is ongoing, or otherwise continuous throughout the lifecycle of the customer's relationship with the financial institution. In addition to providing for a risk assessment that may fluctuate throughout the lifecycle of the customer, the desired process should provide for standardization and globalization, such that it can be implemented across the entire worldwide customer population. Such methodologies should provide for identification of customers that truly present money laundering or illegal activity risk, thereby enabling the financial institutions to have greater visibility into the risk associated their business at both the customer and business line level.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for providing risk assessments to an entire financial institution customer population, which for large entities may be global. Specifically, the present invention provides for risk ranking the customer population throughout the lifecycle of the customer's relationship with the financial institution. For example, a customer may be risk ranked at the inception of their relationship with the financial institution (e.g., when a customer initially opens an account, commonly referred to as “onboarding”) with periodical assessments (e.g., monthly or the like) to assess the need to re-rank the customer based on activities/risk factors associated with the customer occurring during the period. In one specific embodiment, the risk ranking is streamlined to three risk rank tiers; standard risk, medium risk and high risk. Such risk ranking is distinguishable from other risk assessments in that it provides for one comprehensive global solution for measuring the risk of all customers. In addition, by providing for risk ranking in terms of tiers or levels the present invention does not rely on risk scoring each of the customers. Moreover, the risk ranking does not directly rely on customer transaction data, and, as such, is more accurate and efficient in identifying those customers that truly present a money laundering risk.

A method for customer risk assessment of a financial institution customer population defines first embodiments of the invention. The method includes receiving risk-identifying data associated with customers in the financial institution customer population and identifying predetermined risk factors in the risk-identifying data, each risk factor is associated with at least one of the customers. The method further includes determining, on a recurring basis, a risk ranking for each of the customers in the population based on application of a predetermined risk ranking rule associated with each of the identified risk factors.

In specific embodiments of the method, determining the risk ranking further includes assigning each of the customers in the population to a risk tier based on application of the predetermined risk ranking rule associated with each of the identified risk factors. In further related embodiments of the method, assigning each of the customers in the population to one of a standard risk tier, a medium risk tier or a high risk tier. In still further related embodiments of the method, assigning each of the customers in the population to a risk tier based on application of the predetermined risk ranking rule further defines the risk ranking rule as one of increasing the risk tier by one tier, increasing the risk tier to a highest risk tier, increasing and maintaining the risk tier at a highest risk tier, or decreasing the risk tier by one tier.

In still further specific embodiments of the method, determining, on the recurring basis, the risk ranking further includes determining the risk ranking of each customer proximate to onboarding each customer and periodically throughout a lifecycle of each customer.

In additional specific embodiments of the method, receiving the risk-identifying data further defines the risk-identifying data as customer attribute data and customer activity data. In related embodiments of the method, identifying predetermined risk factors further defines the risk factors in the customer attribute data as including one or more of customer type (i.e., business or individual), geographic presence of the customer, citizenship of the customer, customer occupation, customer business type or the like. In other related embodiments of the method, identifying predetermined risk factors further defines the risk factors in the customer activity data as including one or more of government-mandated reporting of suspicious activities, discretionary reporting of suspicious activities, suspicious activity investigation, transactions rejected due to economic sanctions with a designated foreign country or a designated individual, transactions blocked due to economic sanctions with a designated foreign country or a designated individual, government inquiries, government mandate to keep customer accounts open, or absence of risk-related activity over a predetermined period of time.

A system for customer risk assessment of a financial institution customer population defines second embodiments of the invention. The system includes a computing platform having a memory and a processor in communication with the memory. The system further includes a risk ranking rules database stored in the memory and configured to store a plurality of risk ranking rules, each risk ranking rule being associated with a predetermined risk factor. The system further includes a customer risk assessment module that is stored in the memory and executable by the processor. The module is configured to receive risk-identifying data associated with customers in the customer population, identify risk factors in the risk-identifying data, and determine, on a recurring basis, a risk ranking for each of the customers in the population based on application of one of the risk ranking rules to a corresponding identified risk factor.

In specific embodiments of the system, the customer risk assessment module is further configured to assign each of the customers in the population to a risk tier based on application of a predetermined risk ranking rule associated with each of the identified risk factors. In related embodiments of the system, the risk tier is one of a standard risk tier, a medium risk tier or a high risk tier. In further related embodiments, the customer risk assessment module is further configured to assign each of the customers in the population to a risk tier based on application of the predetermined risk ranking rule, wherein the risk ranking rule is defined as one of increasing the risk tier by one tier, increasing the risk tier to a highest risk tier, increasing and maintaining the risk tier at a highest risk tier, or decreasing the risk tier by one tier.

In further specific embodiments of the system, the customer risk assessment module is further configured to determine the risk ranking of each customer proximate to onboarding each customer and periodically throughout a lifecycle of each customer.

In additional specific embodiments of the system, the customer risk assessment module is further configured to receive the risk-identifying data, wherein the data is further defined as customer attribute data and customer activity data. In such embodiments, the system may further include (1) a customer profile configured to provide the module with the customer attribute data for each of the customers, (2) an external event collection application configured to provide the module with at least a portion of the customer activity data including one or more of government released data or media-released data, (3) an AML case management application configured to provide the module with at least a portion of the customer activity data including one or more of Suspicious Activity Report (SAR) data or investigation case data, (4) an economic sanction management application configured to provide the module with at least a portion of the customer activity data including one or more of data associated with transactions rejected due to economic sanctions, data associated with transactions blocked due to economic sanctions or customers with economic sanction licenses, and/or (5) a foreign activity depository stored in the memory, executable by the processor and configured to provide the module with at least a portion of the customer activity data including one or more of Suspicious Transaction Report (STR) data, foreign government customer inquiry data or requests from foreign governments to maintain an open status of a customer account.

In further specific embodiments of the system, the customer risk assessment module is further configured to identify the predetermined risk factors, wherein the risk factors in the customer attribute data include one or more of customer type, geographic presence of the customer, citizenship of the customer, customer occupation, customer business type or an economic sanction license. While in other specific embodiments of the system, the customer risk assessment module is further configured to identify the predetermined risk factors, wherein the risk factors in the customer activity data include one or more of government-mandated reporting of suspicious activities, discretionary reporting of suspicious activities, suspicious activity investigation, transactions rejected due to economic sanctions with a designated foreign country or a designated individual, transactions blocked due to economic sanctions with a designated foreign country or a designated individual, government inquiries, government mandate to keep customer accounts open, or absence of risk-related activity over a predetermined period of time.

A computer program product including a non-transitory computer-readable medium defines third embodiments of the invention, The computer-readable medium includes computer-executable instructions configured to cause a computer to implement the steps of receiving risk-identifying data associated with customers in the financial institution customer population, identifying predetermined risk factors in the risk-identifying data, each risk factor being associated with at least one of the customers and determine, on a recurring basis, a risk ranking for each of the customers in the population based on application of a predetermined risk ranking rule associated with each of the identified risk factors.

Thus, further details are provided below for systems, apparatus, methods and computer program products for providing risk assessments to a financial institution customer population. Specifically, the present invention provides for risk ranking the customer population throughout the lifecycle of the customer's relationship with the financial institution. In specific embodiments, the risk ranking is efficiently based on three risk rank tiers; standard risk, medium risk and high risk. Thus, the present invention provides for one comprehensive global solution for measuring the risk of all customers within a financial institution population. In addition, by providing for risk ranking in terms of tiers or levels the present invention does not rely on complex risk scoring of each customer. Further, since the risk ranking of the present invention does not directly rely on customer transaction data it tends to be more accurate and efficient in identifying those customers that truly present a money laundering risk.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Reference will now be made to the accompanying drawings, which are not necessarily drawn to scale, and wherein:

FIG. 1 is a block diagram of an apparatus configured for risk assessment of a financial institution customer population, in accordance with an embodiment of the present invention;

FIG. 2 is a block diagram of an apparatus configured for risk assessment of a financial institution customer population highlighting alternate embodiments, in accordance with further embodiments of the present invention;

FIG. 3A is a block diagram of risk factors based on customer attribute/profile data, in accordance with embodiments of the present invention;

FIG. 3B is a block diagram of risk factors based on customer activity data, in accordance with embodiments of the present invention;

FIG. 4 is a block diagram of a system for ongoing risk assessment including sources for risk-identifying data, in accordance with embodiments of the present invention;

FIG. 5 is flow diagram of a method for risk ranking in conjunction with three risk tiers, in accordance with embodiments of the present invention; and

FIG. 6 is a flow diagram of a method for risk assessment of a financial institution customer population, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments of the present invention, the functions described may be implemented in hardware, software, firmware, or any combination thereof. If implemented in software, the functions may be stored or transmitted as one or more instructions or code on a computer-readable medium. Computer-readable media includes both computer storage media and communication media, including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

In general, embodiments of the present invention relate to systems, methods and computer program products for risk assessing a global financial institution customer population. Specifically, the present invention provides for risk ranking the customer population throughout the lifecycle of the customer's relationship with the financial institution. For example, a customer may be risk ranked at the inception of their relationship with the financial institution (e.g., when a customer initially opens an account, commonly referred to as “onboarding”) in addition to periodical assessments (e.g., monthly or the like) for the purpose of evaluating the need to re-rank the customer based on activities/risk factors associated with the customer occurring during the period. In specific embodiments of the invention, the risk ranking provides for three risk ranking tiers; standard risk, medium risk and high risk. In such embodiments of the invention, a customer may be placed in one of the three risk ranking tiers based on customer attributes and/or activities and may, if the ranking allows for such, move from tier-to-tier based on changes in attributes or occurrence of activities during an assessment period.

As such, the risk ranking of the present invention provides for one standardized and comprehensive global solution for measuring the risk of all customers. In addition, by providing for risk ranking in terms of tiers or levels the present invention provides a simplified and accurate means to assess risk that does not rely on a more complicated risk scoring of each the customers. Moreover, the risk ranking of the present invention relies on predetermined risk factors that result in an accurate and efficient means for identifying customers that truly present a money laundering risk.

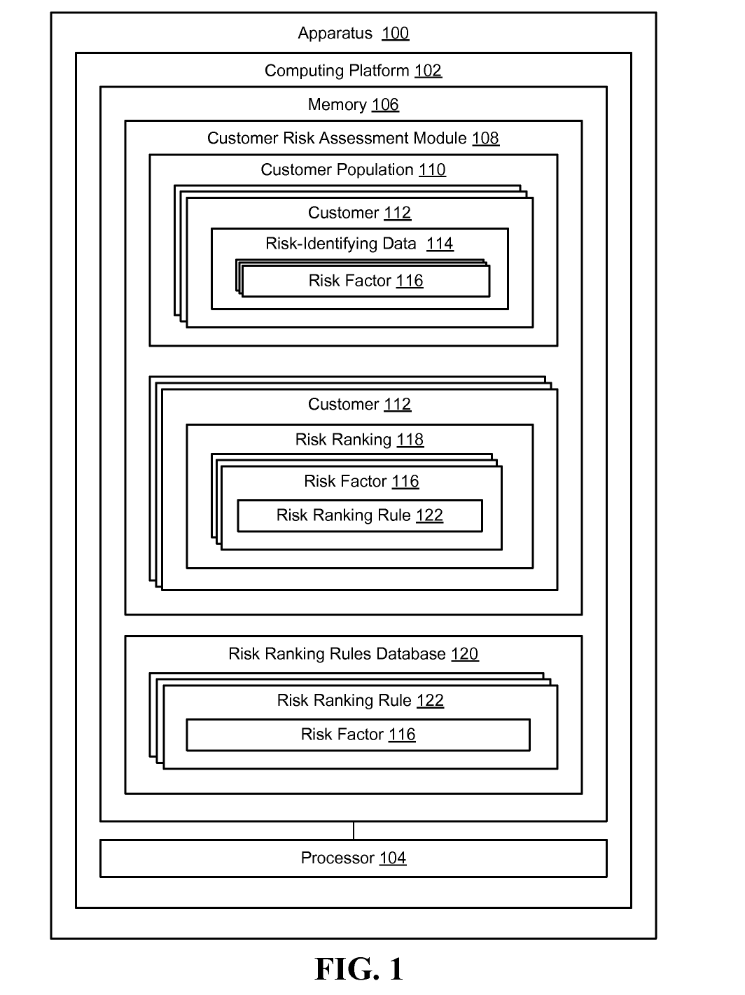

Referring to FIG. 1 a block diagram is depicted of an apparatus 100 configured to provide risk assessment for a financial institution customer population, in accordance with embodiments of the present invention. The apparatus 100 includes a computing platform 102 having a memory 106 and a processor 104 in communication with the memory. The memory 106 of apparatus 100 stores customer risk assessment module 108, which is configured to provide risk assessment, in the form of risk ranking 118, for a financial institution customer population 110. A customer population 110 as used herein refers to most, and in many embodiments all, of the financial institution current customers.

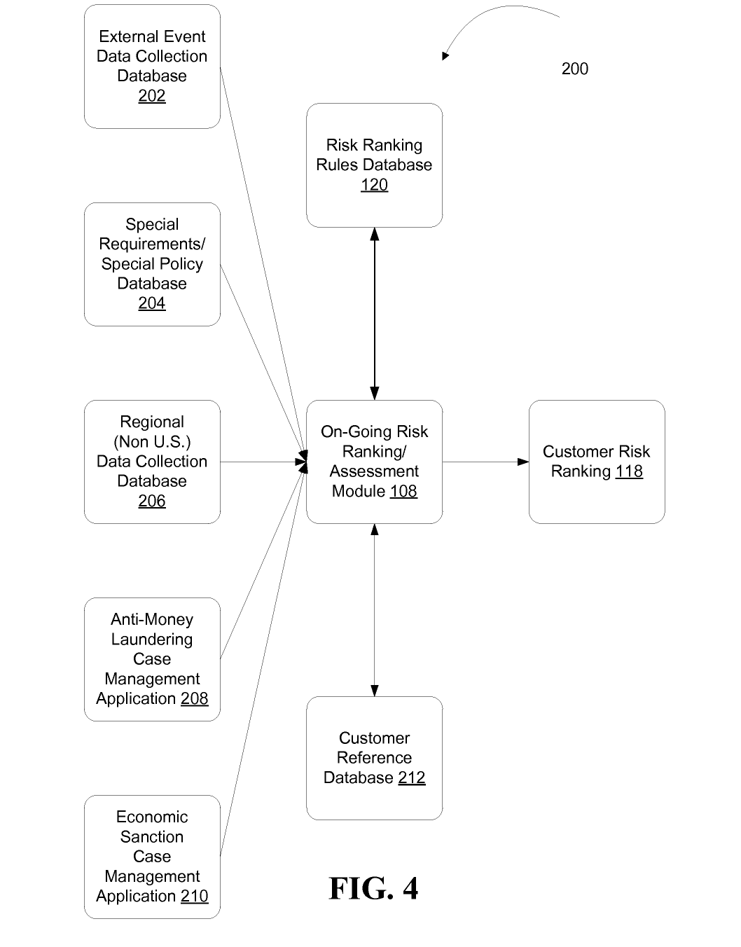

The customer risk assessment module 108 is configured to receive risk-identifying data 114 from a plurality of sources (not shown in FIG. 1). The risk-identifying data 114 is associated with the plurality of customers 112 that comprise the costumer population 110. The sources of the risk-identifying data are detailed in the discussion related to FIG. 4, infra.

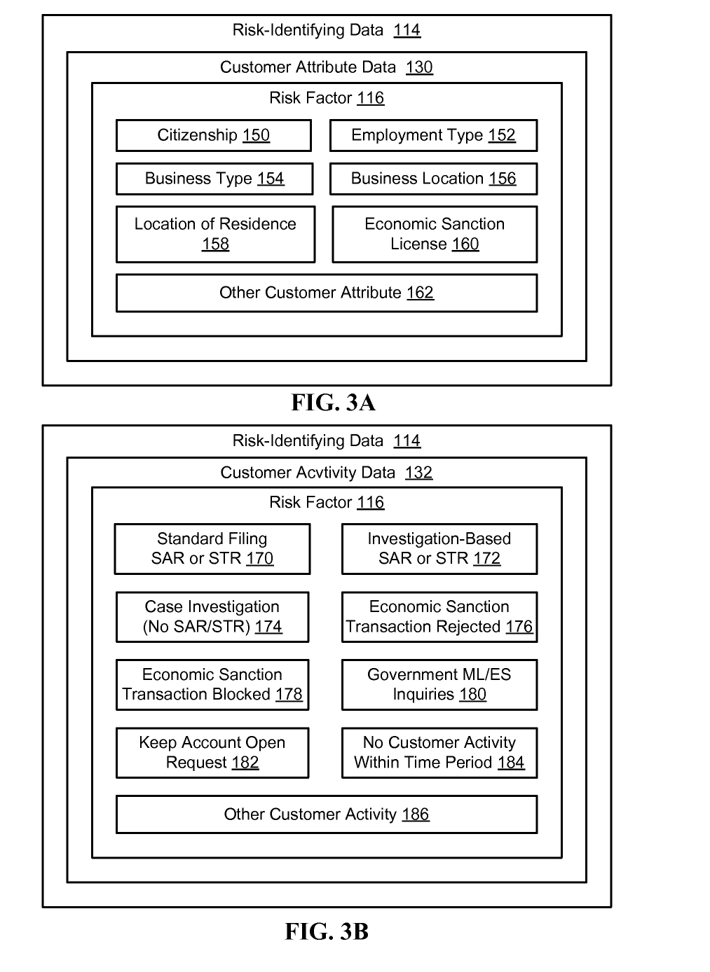

Further, the customer risk assessment module 108 is configured to identify predetermined risk factors 116 in the risk-identifying data 114. The risk factors 116 are customer attributes and customer activities that have been designated by the user of the module 110 (i.e., risk management personnel or the like) as having an effect on the risk ranking 118 of the customer 112. Examples of risk factors, according to specific embodiments of the present invention, are described in relation to FIGS. 3A and 3B, infra.

In addition, customer risk assessment module 108 is configured to determine, on a recurring basis, a risk ranking 118 for each customer 112 based on application of a predetermined risk rule 122 to each of the risk factors 116 associated with the customer. As such, the memory 108 of apparatus 100 additionally includes risk ranking rules database 120 that stores a plurality of predetermined risk ranking rules 122, each risk ranking rule 122 being associated with a predetermined risk factor 116. In specific embodiments of the invention the risk ranking rules may include, but are not limited to, elevating the risk ranking by one or more risk tiers, decreasing the risk ranking by one or more risk tiers, elevating and holding (either permanently or for a predetermined time period) the risk ranking to a predetermined risk tier, lowering and holding (either permanently or for a predetermined time period) the risk ranking to a predetermined risk tier or the like.

For the purposes of this invention, determination of the risk ranking on a “recurring basis” provides for determination of the risk ranking throughout the lifecycle of the customer's relationship with the financial institution. In specific embodiments of the invention, determining the risk ranking on a “recurring basis” provides for determining a risk ranking at the inception of the customer's relation (i.e., when the customer initially opens an account with the financial institution, commonly referred to as the “onboarding” stage) and periodically throughout the remaining lifecycle of the customer's relationship with the financial institution. As such, the determination may occur automatically at predetermined intervals, such as once a month, bi-monthly, for the entire customer population or the like and/or the determination may occur for individual customers based on occurrence of an event, such as applying for loan, opening an account, large amount deposit/withdrawal or the like.

It should be noted that the risk assessment of the present invention provides for a risk ranking as opposed to a risk score and, therefore results in a simplified and efficient approach to risk management. Moreover, since the determination of the risk ranking is based on risk factors, efficiency in risk assessment is further realized because only those customers which have incurred a change in their risk factors (i.e., a change in a customer attribute or occurrence of a customer activity) will be considered for or undergo a change in their respective risk ranking during the periodical customer-wide risk ranking.

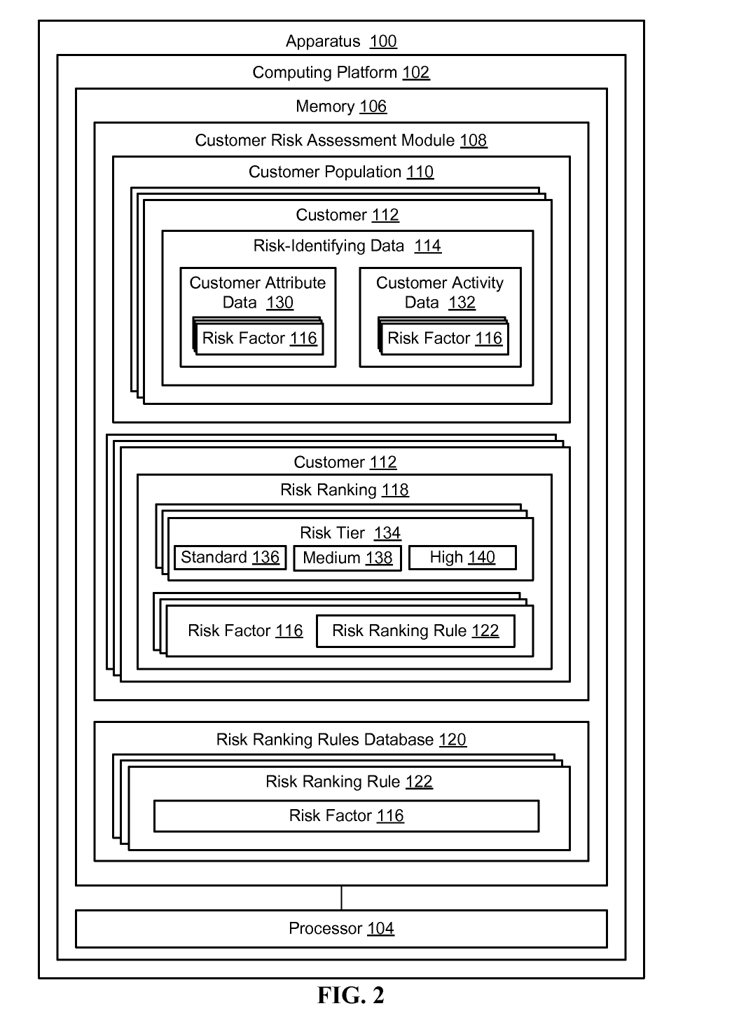

Referring to FIG. 2 a block diagram is depicted of the apparatus 100 configured to provide risk assessment for a financial institution customer population, in accordance with specific embodiments of the present invention. In the specific embodiments shown in FIG. 2, the customer risk assessment module 108 is configured to receive the risk-identifying data 114 in the form of customer attribute data 130 and customer activity data 132. Customer attribute data otherwise referred to herein as customer profile data may include, but is not limited to, the customer's physical address, customer's business location(s), citizenship, job title/classification, special requirements (e.g., economic sanction license, etc.) or the like. Customer activity data may include AML case management data, economic sanction case management data, government (United States and non-United States) inquiry data, government (United States and non-United States) requests to keep accounts active, special requirements external data, such as media events associated with the customer, or the like.

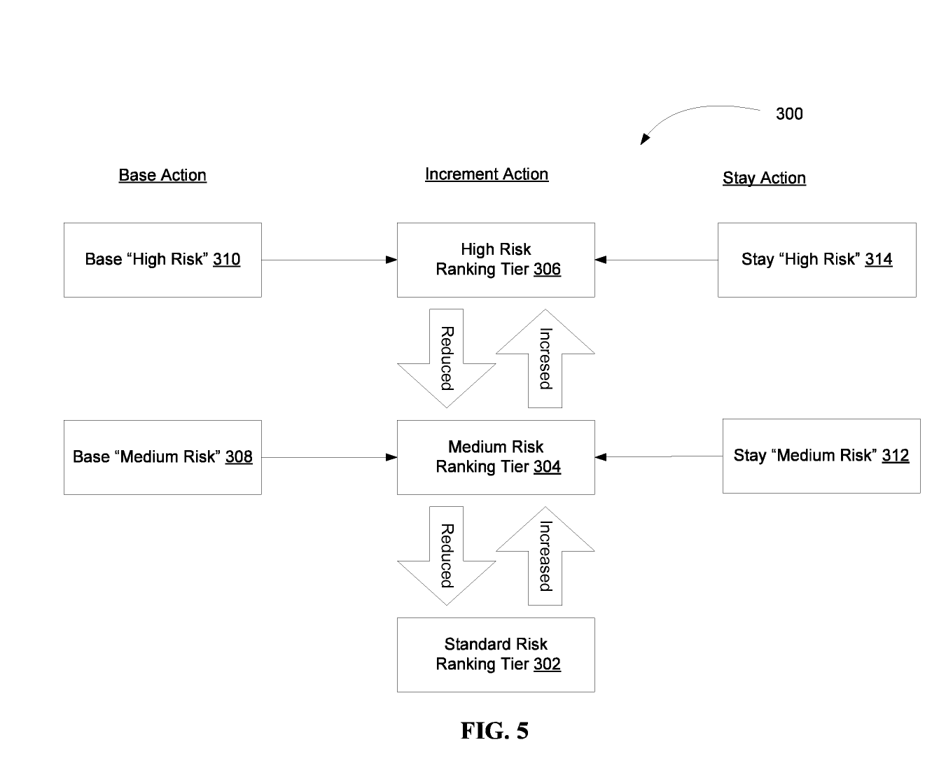

In addition, according to other specific embodiments of the invention, the customer risk assessment module 108 is configured to determine risk ranking in the form of assigning the customer to a predetermined risk tier 134. In one specific embodiment of the invention, the risk tiers 134 are defined as three risk tiers 134; specifically, a standard risk tier 136, a medium risk tier 138 and a high risk tier 140. In such embodiments a customer may assigned to one of the three risk tiers during the onboarding process and may remain at that risk tier or move to a higher or lower risk tier upon subsequent recurring risk ranking determinations. Further details related to risk tier movement is discussed in relation to the flow diagram of FIG. 5, infra. It should also be noted that each risk tier may be defined by criteria for further monitoring of the customers that are assigned to that particular risk tier and/or the limitations/restrictions placed on customers assigned to that particular risk tier.

FIGS. 3A and 3B provide block diagrams of the risk factors 116 which may be included customer attribute data 130 (FIG. 3A) and customer activity data 132 (FIG. 3B), in accordance with specific embodiments of the present invention.

Referring to FIG. 3A, the customer attribute data 130 risk factors 116 may include a designated citizenship 150, a designated employment type 152, a designated business type 154, a designated business location/presence 156, a location of residence 158, issuance of an economic sanction license 160 and other customer attribute 162. In specific embodiment of the invention in which the risk ranking employs risk tiers, the risk ranking rule associated with customer attribute data 130 risk factors 116 may be elevating and maintaining the customer at a designated risk tier. If the designated risk tier is the highest risk tier, the customer may not be lowered to any risk tier below the highest risk tier as long as the risk factor exists (i.e., the risk tier may (but is not necessarily required to be) be lowered if the risk factor no longer applies, e.g., employment/business type changes, business location changes or the like). If the designated risk tier is less than the highest tier, the system may be configured such that the customer may be elevated to higher risk tiers if risk factors so dictate but the customer may not be allowed to be lowered to risk tiers below the designated risk tier. For example, in a three risk tier system, if the risk rule provides for elevating and maintaining the customer at a medium risk tier, the customer may be elevated to the highest risk tier if risk factors so dictate but the customer may not, regardless of risk factors, be lowered to the standard risk tier.

In specific embodiments of the invention, citizenship 150 may be further defined as citizenship in a country having economic sanctions or citizenship in a country otherwise designated by the risk ranking system. Citizenship is typically provided for by the customer or otherwise determined/verified during the onboarding process.

In further specific embodiments of the invention, a designated employment type 152 or a designated business type 154 may provide for a risk factor 116. The designated employment type 152 or business type 154 may be an employment or business type typically associated with and/or highly likely to engage in illegal financial activity, such as an employment type 152 or business type 154 being more prone to engage in money laundering or the like. The employment type and/or business type of the customer is provided by the customer or otherwise identified during the onboarding process, although in other instance, in which the customer changes employment type and/or business type during their customer lifecycle, the employment type 152 or business type 154 may be provided/identified at any point in time during the lifecycle.

In still further specific embodiments of the invention, a designated business location 156 may be defined as a non-United States customer having operations (physical or otherwise) in an economically sanctioned country. Business location/presence 156 is typically provided for by the customer or otherwise determined/verified during the onboarding process, although in other instance, in which the customer changes/adds business locations/presence during their customer lifecycle, business location/presence may be provided/identified at any point in time during the lifecycle. In still other specific embodiment of the invention, the location of the customer's residence 158 in combination with rules, standards, policies and the like in place at the location (e.g., foreign country rules, polices or state rules, policies or the like).

In additional specific embodiments of the invention, an economic sanction license 160 may be issued to a customer. The economic sanction license 160 provides for the customer to transact in a country designated with economic sanctions (i.e., customer transactions would otherwise by rejected or blocked absent the economic sanction license). The issuance of an economic sanction license may be granted to a customer during their onboarding process or at any time during their customer lifecycle and the associated risk ranking rule applied during the onboarding process or at a subsequent recurring risk ranking determination.

It should be noted that other customer attributes 162 may be identified as risk factors 116 based on the concerns of the financial institution, trends in illegal/money laundering activities and the like. Such other customer attributes 162 may provide for a maintained/permanent risk factor (i.e., a risk factor that affects the customer's risk ranking for their entire customer lifecycle and, thus, the risk ranking cannot be lowered) or a temporary risk factor (i.e., a risk factor that affects the customer's risk ranking for a designated period of time and, thus, may allow for lowering of the risk ranking). In certain embodiments of the invention, laws, standards, procedures and the like may dictate that certain individuals (as defined by prescribed customer attributes) be assigned to an elevated risk ranking. In such embodiments, it may be additionally prescribed that the customer remain at the prescribed elevated risk ranking regardless of other risk factors that would otherwise lower the risk ranking.

Referring to FIG. 3B, the customer activity data 132 risk factors 116 may include an issuance of a standard filing Suspicious Activity Report (SAR) (or, as referred to in countries other than the United States, a Suspicious Transaction Report(STR)) 170, an issuance of an investigation-based SAR or STR 172, a case investigation that does not result in a SAR or STR 174, rejection of a transaction due to economic sanctions 176, blocking of a transaction due to economic sanctions 178, government (United States or non-United States) inquiries related to money laundering or economic sanctions 180, government (United States or non-United States) requests to keep accounts open 182, no customer activity within a predefined time period 186 and other customer activity 184.

In specific embodiment of the invention in which the risk ranking employs risk tiers, the risk ranking rule associated with customer activity data 132 risk factors 116 may be elevating the risk tier by one or more risk tiers or elevating and maintaining the customer at a designated risk tier. Similar to processes discussed in relation to customer attribute 130 risk factors 116, if the designated risk tier is the highest risk tier, the customer may not be lowered to any risk tier below the highest risk tier as long as the risk factor exists (i.e., the risk tier may (but is not necessarily required to be) be lowered if the risk factor no longer applies, e.g., employment/business type changes, business location changes or the like). If the designated risk tier is less than the highest tier, the system may be configured such that the customer may be elevated to higher risk tiers if risk factors so dictate but the customer may not be allowed to be lower to risk tiers below the designated risk tier.

In specific embodiments of the invention, a standard filing SAR or STR 170 is defined as SAR or STR that must, automatically without exception, be filed with the corresponding government agency due to the occurrence of a predetermined suspicious event(s). The risk ranking of customers that are parties associated with the SAR or STR may be impacted. In such embodiments the risk ranking rule may differ based on the whether the customer is an individual or a business and/or the volume of SARs and/or STRs associated with the business or individual. For example, the risk ranking rule for individual customers may dictate that the occurrence of one (1) standard filing SAR or STR results in the risk ranking being elevated by one tier and the occurrence of two (2) or more standard filing SARs or STRs results in the risk ranking being elevated by two tiers (or to the highest tier if the individual customer previously existed in the next-to-highest ranked tier). Thus, for a three tier system (standard, medium and high), the occurrence of one (1) standard filing SAR or STR results in the risk ranking for an individual customer being elevated from the standard tier to the medium tier or from the medium tier to the high tier and the occurrence of two (2) or more standard filing SARs or STRs results in the risk ranking for an individual customer being elevated to the high tier. Conversely, the risk ranking rule for business customers may dictate that the occurrence of two (2) standard filing SAR or STR results in the risk ranking being elevated by one tier and the occurrence of three (3) or more standard filing SARs or STRs results in the risk ranking being elevated by two tiers (or to the highest tier if the business customer previously existed in the next-to-highest ranked tier). Thus, for a three tier system (standard, medium and high), the occurrence of two (2) standard filing SAR or STR results in the risk ranking for a business customer being elevated from the standard tier to the medium tier or from the medium tier to the high tier and the occurrence of three (3) or more standard filing SAs or STRs results in the risk ranking for a business customer being elevated to the high tier.

In other specific embodiments of the invention, an investigated-based SAR or STR 172 is defined as SAR or STR that was not mandated to be filed due to the occurrence of a predetermined suspicious event(s) but rather resulted from the financial institution investigating suspicious activities conducted by the customer. In specific embodiment of the present invention, such investigation-based SARs/STRs, the associated risk rule may not be customer-type-specific (i.e., individual or business) nor volume-dependent. In further specific embodiments of the invention, the risk ranking rule may dictate that the occurrence of one (1) or more SARs or STRs results in the results in the risk ranking being elevated by two tiers (or to the highest tier if the business customer previously existed in the next-to-highest ranked tier). Thus, for a three tier system (standard, medium and high), the occurrence of one (1) or more investigation-based SAR or STR results in the risk ranking being elevated (from either the standard tier or the medium tier) to the high tier.

In further specific embodiments of the invention, a case investigation that does not result in a SAR or STR 174 may define a risk factor 116. Since the case investigation did not result in filing of a SAR or STR, the risk associated with the case investigation is typically perceived to be less than the risk associated with the filing of a SAR/STR. Thus, in such embodiments, the associated risk rule may be volume-dependent, such that more than one occurrence of a case investigation that does not result in a SAR or STR would need to occur for the rank ranking to be elevated. In further such embodiments of the invention the risk rule associated with a case investigation that does not result in a SAR or STR 174 may dictate that occurrence of one (1) (or in some embodiments more than one) case investigation absent SAR/STR results in the risk ranking being elevated by one tier. Thus, for a three tier system (standard, medium and high), the occurrence of one (1) or more case investigation absent SAR/STR results in the risk ranking for being elevated from the standard tier to the medium tier or from the medium tier to the high tier.

In additional specific embodiments of the invention, customer transactions that are either rejected due to economic sanctions 176 or blocked (i.e., placed on hold pending review) due to economic sanctions 178 may define risk factors. Economic sanctions are defined as restrictions placed by one country on another country which limit, and in some instances forbid, transactions/trade between businesses/entities lying within the sanctioned country. Thus, as used herein the customer has attempted to conduct a transaction with business entity within a sanctioned country and the transaction has either been blocked or rejected. In certain embodiments of the invention transactions rejected and transactions blocked due to economic sanction are treated the same in terms of the risk ranking rule applied (in other words, the occurrence of either a rejection or a block results in the same level of increase in the risk ranking), while in other embodiments a transaction rejection and transaction block may be treated differently in terms of the risk rule applied, for example, a rejected transaction may result in a higher level of increase in the risk ranking than a blocked transaction or a greater a volume of block transaction need to occur to result in elevating the risk ranking than the volume of rejected transactions. Thus, the risk ranking rule for rejected or blocked transactions due to economic sanctions may dictate that the occurrence of one (1) rejection or block results in the risk ranking being elevated by one tier and the occurrence of two (2) or more rejected or blocked transactions due to economic sanctions results in the risk ranking being elevated by two tiers (or to the highest tier if the individual customer previously existed in the next-to-highest ranked tier). Thus, for a three tier system (standard, medium and high), the occurrence of one (1) rejected or blocked transaction due to economic sanctions results in the risk ranking being elevated from the standard tier to the medium tier or from the medium tier to the high tier and the occurrence of two (2) or more rejected or blocked transactions due to economic sanctions results in the risk ranking for an individual customer being elevated to the high tier.

In still further specific embodiments, government inquires (both United States and non-United States) related to money laundering or economic sanctions 180 and government (United States and non-United States) requests to keep an customer account open 182 define risk factors. In specific embodiments, the risk ranking rule for the occurrence of a government inquiry 180 or a government request to keep an account open 182 may dictate that the occurrence of one (1) government inquiry or government request results in the risk ranking being elevated by two tiers or to the highest tier and maintaining the risk ranking at elevated risk tier or the highest risk tier. Thus, if the elevated risk tier is the highest risk tier, the customer may not be lowered to any risk tier below the highest risk tier. If the elevated risk tier is less than the highest tier, the customer may be elevated to a higher risk tier if risk factors so dictate but the customer may not be allowed to be lowered to risk tiers below the designated risk tier. For example, in a three risk tier system, the customer is elevated to the high risk tier and maintained at the high risk tier, regardless of risk factors that would otherwise result in a lower risk ranking.

In other specific embodiments of the invention, no occurrence of a customer activity (i.e., risk factors 116) within a predefined period time period 184 may trigger a decrease in the risk ranking. For example, if a customer incurs no SAR or STR, no cases investigated, no economic sanction rejections or blocks, no government inquiries and no government requests to keep an account open over a predefined time period the customer's risk ranking may be decreased. The predetermined time period may be chosen by the financial institution; examples include approximately one year, approximately two years. Approximately three years and the like. In specific embodiments, in which a three risk tiers are implemented, no occurrence of a customer activity within a first predefined time period (e.g., approximately one year or approximately two years) may trigger a lowering of the risk rating by one tier (i.e., from the high risk tier to the medium risk tier or from the medium risk tier to the standard risk tier). In addition, if the customer continues to have no occurrences of customer activity over a second predefined time period (e.g., approximately one year) the risk ranking may be lowered by an addition one tier (i.e., from the medium risk tier to the standard risk tier). Is should be noted that in certain instances some customers may be designated as incapable of risk ranking decrease due to laws, standards, procedures or the like in the jurisdiction in which the customer resides. In such instances even though the customer may incur no occurrences of customer activity over the predefined time period the risk ranking remains at the prescribed risk tier.

Other customer activities 186 may be identified as risk factors 116 based on the concerns of the financial institution, trends in illegal/money laundering activities and the like. Such other customer attributes 162 may provide for a maintained/permanent risk factor (i.e., a risk factor that affects the customer's risk ranking for their entire customer lifecycle and, thus, the risk ranking cannot be lowered) or a temporary risk factor (i.e., a risk factor that affects the customer's risk ranking for a designated period of time and, thus, may allow for lowering of the risk ranking).

Turning the reader's attention to FIG. 4, a block diagram is shown of a system 200 for risk assessment of a financial institution customer population, in accordance with embodiments of the present invention. Specifically, FIG. 4 highlights various sources of risk-identifying data that are used to assess a customer's risk, in accordance with embodiments of the present invention. As described in relation to FIG. 1, the system 200 includes ongoing risk ranking/assessment module 108 which is configured to receive risk-identifying data, identify risk factors associated with customers in the risk-identifying data and determine, an on ongoing basis, a risk rank based on application of a risk rule associated with each identified risk factor.

As such, ongoing risk ranking/assessment module 108 is in communication with risk-identifying data sources; external event data collection database 202, special requirements/special policy database 204, regional data collection database 206, anti-money laundering case management application 208 and economic sanction case management application 210. The risk-identifying data sources are operative to communicate risk-identifying data to the continuous risk ranking/assessment module 108. Such communication may occur continuously as data is received/generated by the source, on a predetermined schedule basis or as requested by the risk ranking/assessment module 108.

External event data collection application 202 is configured to receive and store risk-related data received from external entities (i.e., entities outside of the financial institution). The external entities may include law enforcement entities; such as courts of law; the Federal Bureau of Investigation (FBI); United States Marshals Service and the like. Such law enforcement agencies may be the source for providing government AML or economic sanction inquiries (180 of FIG. 3B), government requests to keep accounts open (182 of FIG. 3B), court documents, such as grand jury subpoena/indictments and the like. Additionally, external entities may include other financial institutions, which may be the source for providing SAR data for such reports filed by the other financial institution. In addition, external entities may include media outlets, which may be the source of general information related to a customer, such as newsworthy information, prominence in a locale or the like.

Special requirements/special policy database 204 is configured to receive and store a list of customers having special requirements/polies/concerns or the like related to risk ranking. For example, as previously discussed, certain jurisdictions/countries may have laws, policies, standards or the like that require certain customers having predefined attributes to be designated a prescribed risk ranking. In addition, the financial institution may classify certain customer attributes, such job type, business type and the like as requiring specific risk rules. For example, customers that are political figures or in the legal profession may be classified for special heightened risk requirements and from a business perspective, businesses such as money lending businesses (e.g., paycheck advance lenders), gambling establishments and the like may be classified for special heightened risk concerns. Additionally, the special requirements/special policy database 204 may include a list of customers having citizenship in sanctioned countries, a list of customers having economic sanction licenses and the like.

Regional (non-United States) data collection database 206 is configured to receive and store risk-identifying data from sources outside of the United States. The risk-identifying data may include data from external entities; such as foreign government law enforcement, foreign judicial system and the like. Additionally, the sources may include special requirements/special concerns lists associated with the foreign/regional jurisdiction, Suspicious Transaction Reports (STRs), Cash Transaction Reports (CTRs) filed with the corresponding regional/foreign government agency.

Anti-Money Laundering (AML) case management application 208 is configured to communicate to the risk ranking/assessment module 108 information related to filed Suspicious Activity Reports (SARs) and cases investigated. Economic sanction case management application 210 is configured to communicate to the risk ranking/assessment module 108 information related to transactions that have been rejected and/or blocked due to economic sanctions existing with a country in which a transacting entity is located.

The risk ranking assessment module 108 is in communication with customer reference database 212 for the purpose of correlating and verifying the identity of customers. The risk-identifying data sources (2020, 204, 206, 208, 210) may implement disparate customer identification mechanisms and the customer reference database 212 serves to correlate the disparate customer identification mechanisms into a consolidated customer identification mechanism, such as a party ID or the like. Additionally, the customer reference database provides additional information related to the customer that may be leveraged by one or more risk factors; such as financial institution branches used by the customer to open accounts, and any other information that may benefit ongoing risk assessment and ranking of the customer population.

Once the risk-identifying data has been received by the risk ranking/assessment module 108 and risk factors identified, the module 108 will communicate with the risk ranking rules database 120 to retrieve the risk rule associated with each identified risk factor. The risk ranking rule provides for the ranking action (e.g., increase, decrease, increase and maintain, etc.) associated with the risk factor. Once the risk ranking rules have been applied to the identified risk factor, the customer risk ranking 118 results.

Referring to FIG. 5 a block is presented of a system 300 for risk ranking, specifically a three risk tier system, in accordance with embodiments of the present invention. The risk tier system 300 includes a standard risk ranking tier 302, a medium risk ranking tier 304 and a high risk ranking tier 306. Certain base actions or baseline actions/attributes may cause a customer to be assigned to the medium risk ranking tier 304 or the high risk ranking tier 306. Examples of baseline actions may include, but are not limited to filing of a SAR/STR (standard filing, investigative filing or other), an economic sanction rejection, an economic sanction block, an economic sanction license, and special requirements/policies due to jurisdiction rules, policies or standards, or the like. In specific embodiments of the invention, a base “medium risk” action/attribute 308 may include, but are not limited to, a certain threshold volume of economic sanction blocks or rejections (e.g., one block or rejection) a certain threshold volume of SARs/STRs (e.g., one SAR/STR for an individual customer and two SARs/STRs for a business customer), existence of an economic sanction or the like. In specific embodiments of the invention, a base “high risk” action/attribute 310 may include, but are not limited to, special requirements/policies due to jurisdiction rules, a certain threshold volume of economic sanction blocks or rejections (e.g., two or more blocks or rejections) a certain threshold volume of SARs/STRs (e.g., two or more SARs/STRs for an individual customer and three or more SARs/STRs for a business customer). Base actions allow for the customer to be reduced to a lower risk ranking tier or increased to a higher risk tier if subsequent risk factors dictate such.

Certain stay actions/attribute may cause a customer to be assigned and maintained at the medium risk ranking tier 304 or the high risk ranking tier 306. Maintaining a customer at a risk ranking tier means that the risk ranking tier may not be lowered and, in some instances, may not be elevated or lowered based on subsequent risk factors. Examples of stay actions/attributes may include, but are not limited to customer citizenship in a sanctioned country, non-United States customer having operations/presence in sanctioned country, government inquiries related to AML or economic sanctions, government requests to keep a customer account active, special requirements/policies due to jurisdiction rules, policies and/or standards, or the like. In specific embodiments of the invention, a stay “medium risk” action/attribute 312 may include, but are not limited to, a certain threshold volume of economic sanction blocks or rejections (e.g., one block or rejection) a customer citizenship in a sanctioned country, a non-United States customer having operations/presence in a sanctioned country or the like. In specific embodiments of the invention, a stay “high risk” action/attribute 314 may include, but are not limited to, government inquiries related to AML or economic sanctions, government requests to keep a customer account active, special requirements/policies due to jurisdiction rules, policies and/or standards, or the like.

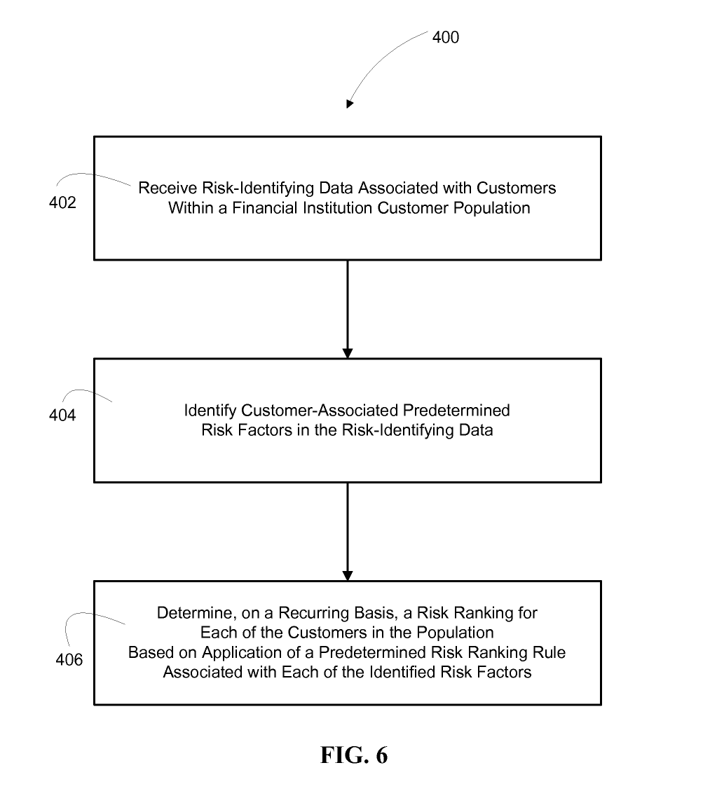

Referring to FIG. 6, a flow diagram is presented of a method 400 for risk assessment of a financial institution customer population, in accordance with embodiments of the present invention. At Event 402, risk-identifying data associated is received. The risk identifying-data is associated with the customers in the financial institution customer population. The risk-identifying data may be further defined as customer attribute data and customer activity data. The risk-identifying data may be received from external event data collection databases, special requirement/special policy databases, regional data collection databases, AML case management systems, economic sanction case management systems and the like.

At Event 404, customer-associated predetermined risk factors are identified in the risk-identifying data. In those embodiments in which the risk-identifying data is further defined as customer attribute data, the risk factors associated with the customer attributes may include customer type (e.g., business or individual), geographic location/presence of the business customer, citizenship of the individual customer, customer occupation, customer business type or an economic sanction license. In those embodiments in which the risk-identifying data is further defined as customer activity data, the risk factors associated with the customer activities may include government-mandated reporting of suspicious activities, discretionary reporting of suspicious activities, suspicious activity case investigation, transactions rejected due to economic sanctions with a designated foreign country or a designated individual, transactions blocked due to economic sanctions with a designated foreign country or a designated individual, government inquiries, government requests to keep a customer account open, or absence of risk-related activity over a predetermined period of time.

At Event 406, a risk ranking is determined, on a recurring or ongoing basis, for each customer in the customer population. The risk ranking is based on application of a predetermined risk ranking rule associated with each of a corresponding risk factor. In specific embodiments the risk ranking is determined, on a recurring basis, by determining the risk ranking of each customer proximate to onboarding each customer and periodically throughout a lifecycle of each customer, such as at predetermined intervals, for example monthly or the like.

In other specific embodiments of the method, the risk ranking is determined by assigning each of the customers in the population to a risk tier based on application of the predetermined risk ranking rule associated with each of the identified risk factors. In further specific embodiments the risk tier is one of a standard risk tier, a medium risk tier or a high risk tier. In such embodiments of the method, the risk ranking rule may include one increasing the risk tier by one tier, increasing the risk tier by two tiers, increasing the risk tier to the medium or high risk tier, increasing and maintaining the risk tier at the medium or high risk tier, decreasing the risk tier by one tier, or decreasing the risk tier by two tiers.

Thus, present embodiments disclosed in detail above provide for systems, apparatus, methods and computer program products for standardized risk assessments to a global financial institution customer population. Specifically, risk assessment provides for risk ranking the customer population throughout the lifecycle of the customer's relationship with the financial institution. In specific embodiments, the risk ranking efficiently includes three concise risk rank tiers; standard risk, medium risk and high risk. Such tier or level-based risk ranking does not rely on risk scoring each of the customers and, therefore, provides an accurate, efficient and simplified means of risk assessment that can be implemented across an entire customer population. In addition, since the risk ranking does not directly rely on customer transaction data, the risk ranking herein described is more accurate and efficient in identifying those customers that truly present a money laundering risk.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for risk assessment of a financial institution customer population, the method comprising:
receiving, at a computing device, risk-identifying data associated with customers in the financial institution customer population;
identifying, by a computing device processor, predetermined risk factors in the risk-identifying data, wherein each risk factor is associated with at least one of the customers; and
determining, by a computing device processor, on a recurring basis, a risk ranking for each of the customers in the population based on application of a predetermined risk ranking rule associated with each of the identified risk factors.

2. The method of claim 1, wherein determining the risk ranking further comprises assigning, by the computing device processor, each of the customers in the population to a risk tier based on application of the predetermined risk ranking rule associated with each of the identified risk factors.

3. The method of claim 2, wherein assigning each of the customers in the population to the risk tier further comprises assigning, by the computing device processor, each of the customers in the population to the risk tier, wherein in the risk tier is one of a standard risk tier, a medium risk tier or a high risk tier.

4. The method of claim 2, wherein assigning, via the computing device processor, each of the customers in the population to a risk tier based on application of the predetermined risk ranking rule further defines the risk ranking rule as one of increasing the risk tier by one tier, increasing the risk tier to a highest risk tier, increasing and maintaining the risk tier at a highest risk tier, or decreasing the risk tier by one tier.

5. The method of claim 1, wherein determining, on the recurring basis, the risk ranking further comprises determining the risk ranking of each customer proximate to onboarding each customer and periodically throughout a lifecycle of each customer.

6. The method of claim 1, wherein receiving the risk-identifying data further defines the risk-identifying data as customer attribute data and customer activity data.

7. The method of claim 6, wherein identifying predetermined risk factors further defines the risk factors in the customer attribute data as including one or more of customer type, geographic presence of the customer, citizenship of the customer, customer occupation, customer business type or an economic sanction license.

8. The method of claim 6, wherein identifying predetermined risk factors further defines the risk factors in the customer activity data as including one or more of government-mandated reporting of suspicious activities, discretionary reporting of suspicious activities, suspicious activity investigation, transactions rejected due to economic sanctions with a designated foreign country or a designated individual, transactions blocked due to economic sanctions with a designated foreign country or a designated individual, government inquiries, government mandate to keep customer accounts open, or absence of risk-related activity over a predetermined period of time.

9. A system for risk assessment of a financial institution customer population, the system comprising:
a computing platform having a memory and a processor in communication with the memory;
a risk ranking rules database stored in the memory and configured to store a plurality of risk ranking rules, wherein each risk ranking rule is associated with a predetermined risk factor; and
a customer risk assessment module stored in the memory, executable by the processor and configured to receive risk-identifying data associated with customers in the customer population, identify risk factors in the risk-identifying data, and determine, on a recurring basis, a risk ranking for each of the customers in the population based on application of one of the risk ranking rules to a corresponding identified risk factor.

10. The system of claim 9, wherein the customer risk assessment module is further configured to assign each of the customers in the population to a risk tier based on application of a the predetermined risk ranking rule associated with each of the identified risk factors.

11. The system of claim 10, wherein the customer risk assessment module is further configured to assign each of the customers in the population to the risk tier, wherein in the risk tier is one of a standard risk tier, a medium risk tier or a high risk tier.

12. The system of claim 10, wherein the customer risk assessment module is further configured to assign each of the customers in the population to a risk tier based on application of the predetermined risk ranking rule, wherein the risk ranking rule is defined as one of increasing the risk tier by one tier, increasing the risk tier to a highest risk tier, increasing and maintaining the risk tier at a highest risk tier, or decreasing the risk tier by one tier.

13. The system of claim 9, wherein the customer risk assessment module is further configured to determine the risk ranking of each customer proximate to onboarding each customer and periodically throughout a lifecycle of each customer.

14. The system of claim 9, wherein the customer risk assessment module is further configured to receive the risk-identifying data, wherein the data is further defined as customer attribute data and customer activity data.

15. The system of claim 14, further comprising a customer profile database stored in the memory and configured to provide the module with the customer attribute data for each of the customers.

16. The system of claim 14, wherein the customer risk assessment module is further configured to identify the predetermined risk factors, wherein the risk factors in the customer attribute data include one or more of customer type, geographic presence of the customer, citizenship of the customer, customer occupation, customer business type or an economic sanction license.

17. The system of claim 14, further comprising an external event data collection application, stored in the memory, executable by the processor and configured to provide the module with at least a portion of the customer activity data including one or more of government released data or media-released data.

18. The system of claim 14, further comprising an Anti-Money Laundering (AML) case management application stored in the memory, executable by the processor and configured to provide the module with at least a portion of the customer activity data including one or more of Suspicious Activity Report (SAR) data or investigation case data.

19. The system of claim 14, further comprising an economic sanction management application stored in the memory, executable by the processor and configured to provide the module with at least a portion of the customer activity data including one or more of data associated with transactions rejected due to economic sanctions, data associated with transactions blocked due to economic sanctions or customers with economic sanction licenses.

20. The system of claim 14, further comprising a foreign activity data collection depository stored in the memory, executable by the processor and configured to provide the module with at least a portion of the customer activity data including one or more of Suspicious Transaction Report (STR) data, foreign government customer inquiry data or requests from foreign governments to maintain an open status of a customer account.

21. The system of claim 14, wherein the customer risk assessment module is further configured to identify the predetermined risk factors, wherein the risk factors in the customer activity data include one or more of government-mandated reporting of suspicious activities, discretionary reporting of suspicious activities, suspicious activity investigation, transactions rejected due to economic sanctions with a designated foreign country or a designated individual, transactions blocked due to economic sanctions with a designated foreign country or a designated individual, government inquiries, government mandate to keep customer accounts open, or absence of risk-related activity over a predetermined period of time.

22. A computer program product, the computer program product comprising a non-transitory computer-readable medium having computer-executable instructions to cause a computer to implement the steps of:
receiving risk-identifying data associated with customers in the financial institution customer population;
identifying predetermined risk factors in the risk-identifying data, wherein each risk factor is associated with at least one of the customers; and
determining, on a recurring basis, a risk ranking for each of the customers in the population based on application of a predetermined risk ranking rule associated with each of the identified risk factors.

23. The computer program product of claim 22, wherein the computer-executable instructions cause the computer to implement the step of determining the risk ranking by assigning each of the customers in the population to a risk tier based on application of the predetermined risk ranking rule associated with each of the identified risk factors.

24. The computer program product of claim 23, wherein the computer-executable instructions cause the computer to implement the step of determining the risk ranking by assigning each of the customers in the population to the risk tier, wherein in the risk tier is one of a standard risk tier, a medium risk tier or a high risk tier.

25. The computer program product of claim 23, wherein the computer-executable instructions cause the computer to implement the step of determining the risk ranking by assigning each of the customers in the population to the risk tier based on application of the predetermined risk ranking rule further defines the risk ranking rule as one of increasing the risk tier by one tier, increasing the risk tier to a highest risk tier, increasing and maintaining the risk tier at a highest risk tier, or decreasing the risk tier by one tier.

26. The computer program product of claim 22, wherein the computer-executable instructions cause the computer to implement the step of determining, on the recurring basis, the risk ranking by determining the risk ranking of each customer proximate to onboarding each customer and periodically throughout a lifecycle of each customer.

27. The computer program product of claim 23, wherein the computer-executable instructions cause the computer to implement the step of receiving the risk-identifying data, wherein the risk-identifying data is further defined as customer attribute data and customer activity data.

28. The computer program product of claim 27, wherein the computer-executable instructions cause the computer to implement the step of identifying predetermined risk factors, wherein the risk factors in the customer attribute data are further defined as including one or more of customer type, geographic presence of the customer, citizenship of the customer, customer occupation, customer business type or an economic sanction license.

29. The computer program product of claim 27, wherein the computer-executable instructions cause the computer to implement the step of identifying predetermined risk factors, wherein the risk factors in the customer attribute data are further defined as including one or more of government-mandated reporting of suspicious activities, discretionary reporting of suspicious activities, suspicious activity investigation, transactions rejected due to economic sanctions with a designated foreign country or a designated individual, transactions blocked due to economic sanctions with a designated foreign country or a designated individual, government inquiries, government mandate to keep customer accounts open, or absence of risk-related activity over a predetermined period of time.
